(19) United States
(12) Patent Application Publication
(10) Pub. No.: US 2023/0021275 A1
(43) Pub. Date: Jan. 19, 2023

(54) Application of Nanosulfur in Tomato Fusarium Wilt Control

(71) Applicant: Jiangnan University, Wuxi (CN)

(72) Inventors: Zhenyu WANG, Wuxi (CN); Xuesong CAO, Wuxi (CN); Chuanxi WANG, Wuxi (CN); Le YUE, Wuxi (CN)

(21) Appl. No.: 17/949,299

(22) Filed: Sep. 21, 2022

Related U.S. Application Data
(63) Continuation of application No. PCT/CN2022/087312, filed on Apr. 18, 2022.

(30) Foreign Application Priority Data
Jun. 9, 2021 (CN) 2021106509585

(51) Int. Cl. A01N 59/02; A01N 25/02; A01P 1/00

(52) U.S. Cl. CPC A01N 59/02; A01N 25/02; A01P 1/00

(57) ABSTRACT

The disclosure discloses application of nanosulfur in tomato fusarium wilt control, belonging to the technical field of novel pesticides. The application of the disclosure includes the following steps: preparing a nanosulfur solution from nanosulfur; and then soaking seeds in the nanosulfur solution or applying the nanosulfur solution onto tomato foliage, and continuing cultivation to obtain tomato plants. The nanosulfur has a particle size of 20-150 nm. The nanosulfur solution uses water as a solvent and has a concentration of 30-200 mg/L. According to the disclosure, after the tomato plants are treated with the nanosulfur by foliar spraying, the fresh weight of the above-ground part is 1.05 times or more that of the disease group, and the fresh weight of the underground part is 1.05 times or more that of the disease group, so that the incidence of tomato fusarium wilt is reduced by 8% or more. After the tomato plants are treated with the nanosulfur by seed soaking, the fresh weight of the above-ground part is 1.38 times or more that of the disease group, and the fresh weight of the underground part is 1.05 times or more that of the disease group, so that the incidence of tomato fusarium wilt is reduced by 20% or more.

### TECHNICAL FIELD

The disclosure relates to application of nanosulfur in tomato fusarium wilt control, belonging to the technical field of novel pesticides.

### BACKGROUND

With the rapid growth of global population, it is estimated that the global demand for food will increase by 60-70% by 2050. The current food production is far from meeting the future demand. It is worth noting that the annual reduction in food production caused by crop diseases and insect pests reaches 10-20%, and with the global climate change (high frequency of high temperature and heavy rain), crop diseases will occur more frequently. Therefore, effective control of crop diseases is one of the ways to ensure the sustainable increase of global food production.

However, the current commercial pesticides are no longer suitable for mass application because of their low utilization rate (<10%), toxicity to non-targeted organisms, harm to human health and other defects. It is urgent to develop an efficient, safe and sustainable method to control crop diseases.

With the development of nanotechnology, nanomaterials have shown great application potential in controlling crop diseases because of their unique physical and chemical properties (nano size, high bioavailability, etc.). However, at present, the research on the control of crop diseases by nanomaterials mainly focuses on copper-based nanomaterials. Compared with the traditional copper-based pesticides, although the copper-based nanomaterials show better performance in controlling crop diseases, they are still not suitable for long-term use because copper enrichment is harmful to the environment.

### SUMMARY

### Technical Problems

The current commercial pesticides are no longer suitable for mass application because of their low utilization rate (<10%), toxicity to non-targeted organisms, harm to human health and other defects. The copper-based nanomaterials, despite of their good effects, are not suitable for long-term use because they are harmful to the environment.

### Technical Solutions

In order to solve at least one of the problems above, according to the disclosure, the nanosulfur is applied to tomatoes as a fertilizer to make the tomatoes resistant to fusarium wilt.

A first object of the disclosure is to provide application of nanosulfur in tomato fusarium wilt control, including the following steps:

preparing a nanosulfur solution from nanosulfur; and then soaking seeds in the nanosulfur solution or applying the nanosulfur solution onto tomato foliage, and continuing cultivation to obtain tomato plants.

In an embodiment of the disclosure, the nanosulfur has a particle size of 20-150 nm, further preferably 30 nm.

In an embodiment of the disclosure, the nanosulfur solution uses water as a solvent and has a concentration of 30-200 mg/L, further preferably 100 mg/L.

In an embodiment of the disclosure, the seed soaking specifically includes:

Before sowing tomato seeds, soaking the tomato seeds in the nanosulfur solution at 23-25° C. at a shaking speed of 140-160 rpm for 12-24 h.

In an embodiment of the disclosure, the foliar application is applied in an amount of 8-12 mL/plant each time, further preferably 10 mL/plant.

In an embodiment of the disclosure, the foliar application is applied by spraying.

In an embodiment of the disclosure, the foliar application is applied when the tomato seeds grow to the 5th-6th week and the 7th-8th week, twice in total.

In an embodiment of the disclosure, a method for preparing the nanosulfur includes the following steps:

adding hexadecyl trimethyl ammonium bromide to a hydrochloric acid solution, and uniformly mixing the mixture in a water bath to obtain a mixed solution; then adding sodium thiosulfate pentahydrate to the mixed solution with stirring, and after the completion of the addition, continuing stirring to obtain a reaction solution; and ultrasonicating and centrifuging the reaction solution, and washing and drying the solid to obtain the nanosulfur.

In an embodiment of the disclosure, a concentration of the hexadecyl trimethyl ammonium bromide is 0.5-1 mM.

In an embodiment of the disclosure, a concentration of the sodium thiosulfate pentahydrate is 3-15 mM.

In an embodiment of the disclosure, a concentration of the hydrochloric acid solution is 3-15 mM.

In an embodiment of the disclosure, the ultrasonicating is ultrasonicating the reaction solution in an ultrasonic cleaner (1 kw) for 30-50 minutes.

In an embodiment of the disclosure, the centrifuging is centrifuging at 10000 rpm for 5-15 minutes.

In an embodiment of the disclosure, the washing is washing with water until pH is 6-7.

In an embodiment of the disclosure, the drying is freeze-drying at a temperature of −80° C. for 48 h.

A second object of the disclosure is to provide a tomato plant cultivated by the application of the disclosure.

A third object of the disclosure is to provide application in the field of agriculture.

### Beneficial Effects

(1) According to the disclosure, after the foliar spraying and the seed soaking, the nanosulfur effectively controls the occurrence of tomato fusarium wilt. After the tomato plants are treated with the nanosulfur by foliar spraying, the fresh weight of the above-ground part is 1.05 times or more that of the disease group, and the fresh weight of the underground part is 1.05 times or more that of the disease group, so that the incidence of tomato fusarium wilt is reduced by 8% or more. After the tomato plants are treated with the nanosulfur by seed soaking, the fresh weight of the above-ground part is 1.38 times or more that of the disease group, and the fresh weight of the underground part is 1.05 times or more that of the disease group, so that the incidence of tomato fusarium wilt is reduced by 20% or more.

(2) Mechanism of the disclosure: The nanosulfur controls the occurrence of the tomato fusarium wilt mainly by inducing systemic acquired resistance of tomatoes (for example, by increasing the concentration of phytoalexin in the tomatoes, and enhancing the antioxidant system in the tomatoes).

### BRIEF DESCRIPTION OF FIGURES

FIG. 1A is a TEM image of 30-SNPs sulfur;

FIG. 1B is a TEM image of 100-SNPs sulfur;

FIG. 1C is a TEM image of SBPs sulfur;

FIG. 2 is XRD patterns of 30-SNPs, 100-SNPs and SBPs;

FIG. 3 shows effects of 100 mg/L 30-SNPs, 100-SNPs, SBPs, sodium sulfate and hymexazol on pathogenic bacteria colonies of tomato fusarium wilt;

FIG. 4A is a TEM image of a tomato stem in the disease group;

FIG. 4B is a partial enlarged view of FIG. 4A, where the white arrows in the figure point to pathogenic bacteria;

FIG. 4C is a TEM image of a tomato stem in the 30-SNPs treated group;

FIG. 4D is a partial enlarged view of FIG. 4B, where the white arrows in the figure point to pathogenic bacteria;

FIG. 4E is an enlarged view of the 30-SNPs observed in FIG. 4D; and

FIG. 4F is an energy spectrum of the 30-SNPs observed in FIG. 4D.

### DETAILED DESCRIPTION

Preferred examples of the disclosure will be described below. It should be understood that the examples are intended to better explain the disclosure and are not intended to limit the disclosure.

### Test Method

There were 5 levels of disease severity of tomatoes: 0: symptomless; 1: mildly stunted; 2: stunted; 3: leaves wilted and yellowed; and 4: dead. The formula for calculating the incidence of tomatoes is shown as Formula (1) below:

$$Incidence = \frac{\begin{matrix}\sum ( Disease severity level of tomatoes \times \\ Number of tomato plants at this disease severity level )\end{matrix}}{\begin{matrix}Highest disease severity level of tomato fusarium \\ wilt \times Total number of tomato plants in treated group\end{matrix}} \qquad ( 1 )$$

The highest disease severity level of tomatoes was Level 4. The total number of tomato plants in the treated group was 6.

Test of biomass of above-ground part and underground part: Tomatoes were sampled destructively. The above-ground part and the underground part of the tomato were washed with ultrapure water three times. The above-ground part and the underground part of the tomato were dried up with filter paper. The above-ground part and the underground part were weighed using a balance. The obtained weights were respectively the biomass of the above-ground part and the underground part of the tomato.

### EXAMPLE 1

A method for preparing nanosulfur included the following steps:

Hexadecyl trimethyl ammonium bromide was added to 100 mL of 3 mM hydrochloric acid solution, and the mixture was uniformly mixed in a water bath at 30° C. to obtain a mixed solution. A concentration of the hexadecyl trimethyl ammonium bromide was 1 mM. Then sodium thiosulfate pentahydrate was added to the mixed solution with stirring. A concentration of the sodium thiosulfate pentahydrate was 3 mM. After the completion of the addition, stirring was continued for 1 hour to obtain a reaction solution. The reaction solution was ultrasonicated for 40 minutes using an ultrasonic cleaner (1 kw). After the completion of the ultrasonicating, the reaction solution was centrifuged at 10000 rpm for 10 min. Then the solid was washed with water until pH was 6.5. Finally, the solid was freeze-dried to obtain the nanosulfur having a particle size of 20-40 nm and a mean particle size of 30 nm (30-SNPs for short).

Hexadecyl trimethyl ammonium bromide was added to 100 mL of 6 mM hydrochloric acid solution, and the mixture was uniformly mixed in a water bath at 30° C. to obtain a mixed solution. A concentration of the hexadecyl trimethyl ammonium bromide was 1 mM. Then sodium thiosulfate pentahydrate was added to the mixed solution with stirring. A concentration of the sodium thiosulfate pentahydrate was 6 mM. After the completion of the addition, stirring was continued for 1 hour to obtain a reaction solution. The reaction solution was ultrasonicated for 40 minutes using an ultrasonic cleaner (1 kw). After the completion of the ultrasonicating, the reaction solution was centrifuged at 10000 rpm for 10 min. Then the solid was washed with water until pH was 6.5. Finally, the solid was freeze-dried to obtain the nanosulfur having a particle size of 80-150 nm and a mean particle size of 100 nm (100-SNPs for short).

Hexadecyl trimethyl ammonium bromide was added to 100 mL of 15 mM hydrochloric acid solution, and the mixture was uniformly mixed in a water bath at 30° C. to obtain a mixed solution. A concentration of the hexadecyl trimethyl ammonium bromide was 1 mM. Then sodium thiosulfate pentahydrate was added to the mixed solution with stirring. A concentration of the sodium thiosulfate pentahydrate was 15 mM. After the completion of the addition, stirring was continued for 1 hour to obtain a reaction solution. The reaction solution was ultrasonicated for 40 minutes using an ultrasonic cleaner (1 kw). After the completion of the ultrasonicating, the reaction solution was centrifuged at 10000 rpm for 10 min. Then the solid was washed with water until pH was 6.5. Finally, the solid was freeze-dried to obtain the big-particle sulfur having a particle size of 1-1.5 μm (SBPs for short).

The obtained 30-SNPs, 100-SNPs and SBPs were tested for their performance. The test results are as follows:

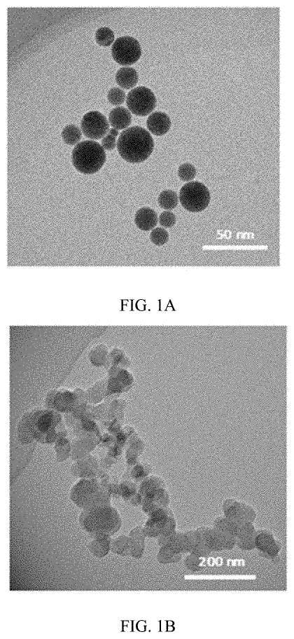

FIG. 1A, FIG. 1B and FIG. 1C are TEM images of 30-SNPs, 100-SNPs and SBPs. As can be seen from FIG. 1A, FIG. 1B and FIG. 1C, the three sulfurs were all spherical.

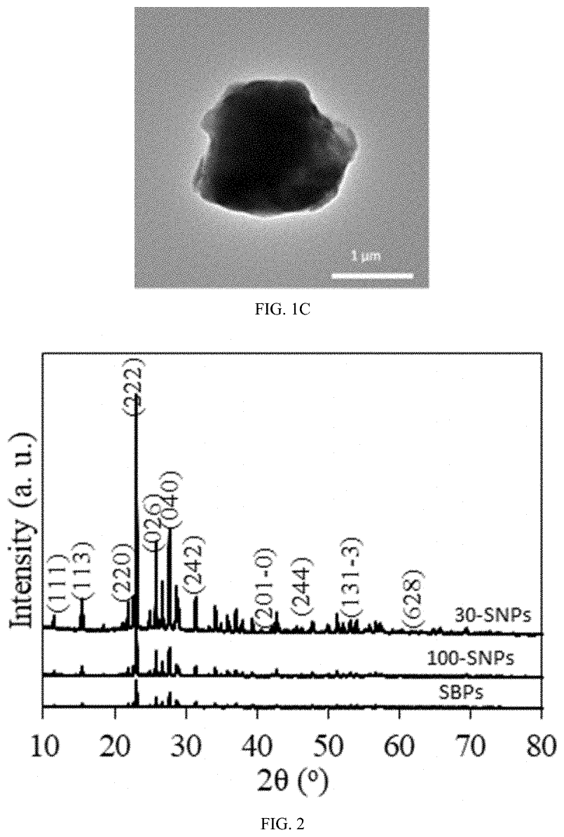

FIG. 2 is XRD patterns of 30-SNPs, 100-SNPs and SBPs. As can be seen from FIG. 2, the three sulfurs were all α-S8 sulfurs.

### EXAMPLE 2 FOLIAR APPLICATION

Application of nanosulfur in tomato fusarium wilt control included the following steps:

(1) Pathogenic bacteria (Fusarium oxysporum f sp. Lycopersici, the pathogen of tomato fusarium wilt) were added to dry soil at a concentration of 1×10⁶ spores/g to obtain infected soil.

(2) Tomato seeds were sowed in the infected soil. When the tomatoes grew to the 6th week and the 8th week, aqueous solutions of 30-SNPs with a concentration of 0 mg/L (foliar disease group), 10 mg/L, 30 mg/L, 50 mg/L, 100 mg/L and 200 mg/L were respectively sprayed onto the foliage of the tomatoes grown in the infected soil in an amount of 10 mL/plant each time. The cultivation was continued.

In the meanwhile, tomato seeds were sowed in soil not infected with pathogenic bacteria, and cultivated normally with no sulfur solution applied, to obtain a healthy group.

The cultivation of the tomatoes was continued until the 10th week. The tomatoes were examined for the disease severity. The tomatoes were sampled destructively. The fresh weights of the above-ground part and the underground part of the tomatoes were measured. The test results are as follows:

TABLE 1
Test results of Example 2

| | Fresh weight of | Fresh weight of | |
|---|---|---|---|
| Concentration of | above-ground | underground | |
| 30-SNPs (mg/L) | part (g) | part (g) | Incidence |
| 0 (healthy group) | 9.3 ± 0.5a | 2.9 ± 0.4a | 0.11 ± 0.05e |
| 0 (foliar disease group) | 5.5 ± 0.8d | 1.7 ± 0.3b | 0.61 ± 0.10a |
| 10 | 6.5 ± 0.8c | 1.8 ± 0.5de | 0.61 ± 0.10a |
| 30 | 6.1 ± 0.8c | 1.8 ± 0.3de | 0.56 ± 0.05a |
| 50 | 7.4 ± 0.7b | 2.3 ± 0.2bc | 0.39 ± 0.05b |
| 100 | 7.7 ± 0.9b | 2.6 ± 0.3ab | 0.31 ± 0.05c |
| 200 | 5.8 ± 0.9cd | 2.1 ± 0.5cd | 0.53 ± 0.05a |

Table 1 shows test effects of tomato plants cultivated after foliar application of sulfur solutions with different concentrations. As can be seen from Table 1, in the disease group, the fresh weights of the above-ground part and the underground part of the tomatoes were significantly reduced by 40.9% and 41.4% respectively as compared with the healthy group, and the incidence reached 0.61. The foliar application of 100 mg/L 30-SNPs showed the best control effect on tomato fusarium wilt, and the fresh weights of the above-ground part and the underground part were respectively 1.4 times and 1.53 times that of the disease group. This foliar application reduced the incidence of tomato fusarium wilt by 49.2%.

### EXAMPLE 3 SEED SOAKING

Application of nanosulfur in tomato fusarium wilt control included the following steps:

(1) Pathogenic bacteria (F. oxysporum, the pathogen of tomato fusarium wilt) were added to dry soil at a concentration of 1×10⁶ spores/g to obtain infected soil.

(2) Before sowing, tomato seeds were soaked in 60 mL of 30-SNPs solutions with a concentration of 0 mg/L (seed-soaked disease group), 10 mg/L, 30 mg/L, 50 mg/L, 100 mg/L and 200 mg/L in a constant temperature incubator (at 24° C. at a shaking speed of 150 rpm/min) for 24 h. Then the tomato seeds were sowed in the infected soil and grown in the infected soil. When the tomatoes grew to the 6th week and the 8th week, water was respectively sprayed onto the foliage of the tomatoes grown in the infected soil in an amount of 5 mL/plant each time.

The cultivation of the tomatoes was continued until the 10th week. The tomatoes were examined for the disease severity. The tomatoes were sampled destructively. The fresh weights of the above-ground part and the underground part of the tomatoes were measured. The test results are as follows:

Table 2 shows test effects of tomato plants cultivated after seed soaking with sulfur solutions with different concentrations. As can be seen from Table 2, in the seed-soaked disease group, the fresh weights of the above-ground part and the underground part of the tomatoes were significantly reduced by 44.1% and 41.4% respectively as compared with the healthy group, and the incidence reached 0.67. The seed soaking of 100 mg/L 30-SNPs showed the best control effect on tomato fusarium wilt, and the fresh weights of the above-ground part and the underground part were respectively 1.38 times and 1.71 times that of the disease group. This seed soaking reduced the incidence of tomato fusarium wilt by 37.3%.

TABLE 2
Test results of Example 3

| Concentration of | Fresh weight of | Fresh weight of | |
|---|---|---|---|
| 30-SNPs | above-ground | underground part | |
| (mg/L) | part (g) | (g) | Incidence |
| 0 (healthy group) | 9.3 ± 0.5a | 2.9 ± 0.4a | 0.11 ± 0.05e |
| 0 (seed-soaked disease | 5.2 ± 0.4c | 1.7 ± 0.3c | 0.67 ± 0.14a |
| group) | | | |
| 10 | 5.2 ± 0.6c | 1.6 ± 0.3c | 0.58 ± 0.08ab |
| 30 | 7.4 ± 0.9b | 1.8 ± 0.3c | 0.53 ± 0.05bc |
| 50 | 7.8 ± 1.2b | 2.7 ± 0.4b | 0.44 ± 0.05cd |
| 100 | 7.2 ± 1.3b | 2.9 ± 0.4ab | 0.42 ± 0.03cd |
| 200 | 7.6 ± 1.2b | 3.1 ± 0.5a | 0.36 ± 0.05d |

### EXAMPLE 4 OPTIMIZATION OF SULFUR SIZE

Application of nanosulfur in tomato fusarium wilt control included the following steps:

(1) Pathogenic bacteria (F. oxysporum, the pathogen of tomato fusarium wilt) were added to dry soil at a concentration of 1×10⁶ spores/g to obtain infected soil.

(2) Tomato seeds were sowed in the infected soil. When the tomatoes grew to the 6th week and the 8th week, 100 mg/L aqueous solutions of 30-SNPs, 100-SNPs, SBPs, sodium sulfate or hymexazol were sprayed onto the foliage of the tomatoes grown in the infected soil in an amount of 10 mL/plant. The cultivation was continued.

In the meanwhile, tomato plants with no fertilizer applied were taken as the foliar disease group.

When the tomatoes grew to the 10th week, the tomatoes were examined for the disease severity. The tomatoes were sampled destructively. The fresh weights of the above-ground part and the underground part of the tomatoes were measured. The test results are as follows:

TABLE 3
Test results of Embodiment 4

| | Fresh weight | Fresh weight of | |
|---|---|---|---|
| | of above- | underground | |
| Treated group | ground part (g) | part (g) | Incidence |
| Healthy group | 9.3 ± 0.5a | 2.9 ± 0.4a | 0.11 ± 0.05e |
| Foliar disease group | 5.5 ± 0.8d | 1.7 ± 0.3b | 0.61 ± 0.10a |
| Hymexazol | 6.9 ± 0.9c | 1.8 ± 0.5b | 0.42 ± 0.08cd |
| 30-SNPs (Example 1 | 7.7 ± 0.9b | 2.6 ± 0.3ab | 0.31 ± 0.05c |
| 100 mg/L) | | | |
| 100-SNPs | 6.5 ± 0.4c | 1.8 ± 0.3b | 0.47 ± 0.05bc |
| SBPs | 5.4 ± 0.6d | 1.8 ± 0.2b | 0.58 ± 0.08ab |
| Sodium sulfate | 5.5 ± 0.7d | 1.7 ± 0.2b | 0.64 ± 0.10a |

Table 3 shows test results of tomato plants obtained after treatment with different solutions. As can be seen from Table 3, compared with the disease group, the foliar spraying of the 30-SNPs, the 100-SNPs and the hymexazol significantly increased the fresh weights of the above-ground part and the underground part of the tomatoes, and the SBPs and the sodium sulfate had no significant effects on the biomass of the tomatoes. The foliar spraying of the 30-SNPs, the 100-SNPs and the hymexazol also significantly reduced the incidence of tomato fusarium wilt. The incidence in the tomatoes treated with the 30-SNPs was 34.04% lower than that treated with the 100-SNPs, and 26.2% lower than that treated with the hymexazol. This indicated that the 30-SNPs with the smallest size had the best control effect on tomato fusarium wilt, and had significantly better control effect than the traditional pesticide hymexazol.

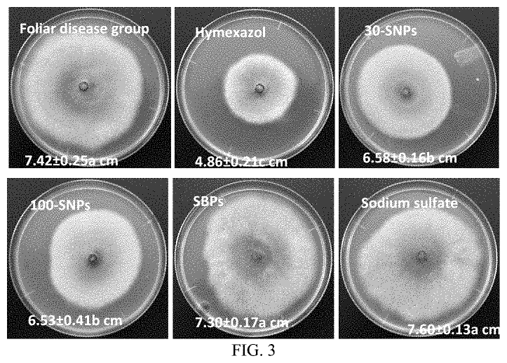

FIG. 3 shows effects of 100 mg/L 30-SNPs, 100-SNPs, SBPs, sodium sulfate and hymexazol on pathogenic bacteria colonies of tomato fusarium wilt. As can be seen from FIG. 3, 100 mg/L 30-SNPs, 100-SNPs and hymexazol, after 6 days of exposure, significantly inhibited the growth of the pathogenic bacteria F. oxysporum on PDA plates, and respectively reduced the diameter of the pathogenic bacteria colonies by 11.3%, 12.0% and 34.5% as compared with the foliar disease group. It is worth noting that the antibacterial effect of the hymexazol was 3.05 times that of the 30-SNPs. This may be because the nanosulfur could induce the systemic acquired resistance of plants and the control effect of the nanosulfur on the tomato fusarium wilt was better than the direct bactericidal effect thereof.

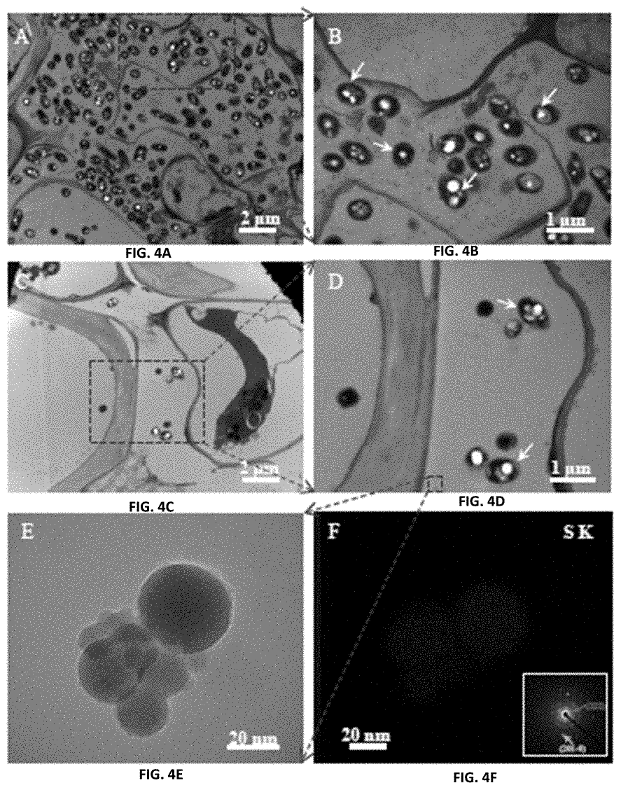

FIG. 4A to FIG. 4F show enlarged views and an energy spectrum of the tomato stem. As can be seen from FIG. 4A to FIG. 4F, the treatment with 30-SNPs significantly reduced the number of pathogenic bacteria in the tomato stem, and the 30-SNPs could be transported to the tomato stem and still exist in the form of nanoparticles.

Although the disclosure has been disclosed as above by way of the preferred examples, they are not intended to limit the disclosure. Any person skilled in the art can make various changes and modifications without departing from the spirit and scope of the disclosure. Therefore, the protection scope of the disclosure should be as defined in the claims.

What is claimed is:

1. Application of nanosulfur in inducing systemic acquired resistance of tomatoes, comprising the following steps:
preparing a nanosulfur solution from nanosulfur; and then soaking seeds in the nanosulfur solution or applying the nanosulfur solution onto tomato foliage, and continuing cultivation to obtain tomato plants; wherein
the nanosulfur has a particle size of 20-150 nm;
the nanosulfur solution uses water as a solvent and has a concentration of 30-200 mg/L;
the foliar application is applied in an amount of 8-12 mL/plant each time; and
the application is application in tomato fusarium wilt control.

2. The application according to claim 1, wherein the seed soaking specifically comprises:
before sowing tomato seeds, soaking the tomato seeds in the nanosulfur solution at 23-25° C. at a shaking speed of 140-160 rpm for 12-24 hours.

3. The application according to claim 1, wherein the foliar application is applied when the tomato seeds grow to the 5th-6th week and the 7th-8th week.

4. The application according to claim 1, further comprising preparing the nanosulfur according to the following steps:
adding hexadecyl trimethyl ammonium bromide to a hydrochloric acid solution, and uniformly mixing the mixture in a water bath to obtain a mixed solution; then adding sodium thiosulfate pentahydrate to the mixed solution with stirring, and after the completion of the addition, continuing stirring to obtain a reaction solution; and ultrasonicating and centrifuging the reaction solution, and washing and drying the solid to obtain the nanosulfur.

5. The application according to claim 4, wherein a concentration of the sodium thiosulfate pentahydrate is 3-15 mM; and a concentration of the hydrochloric acid solution is 3-15 mM.
